(19) United States
(12) Patent Application Publication
(10) Pub. No.: US 2011/0193496 A1
(43) Pub. Date: Aug. 11, 2011

(54) CONTROL SYSTEMS

(75) Inventor: David Finch, East Sussex (GB)

(73) Assignee: Econolight International, a United Kingdom Corporation, Nutley (GB)

(21) Appl. No.: 13/020,754

(22) Filed: Feb. 3, 2011

(30) Foreign Application Priority Data
Feb. 8, 2010 (GB) GB 1001996.6

(51) Int. Cl. H05B 37/02

(52) U.S. Cl. 315/307

(57) ABSTRACT

A lighting control system comprises an input for receiving a mains supply voltage; an output for providing an output voltage signal for powering plural lamps; a controller; a first transformer connected to the input and being for reducing the mains supply voltage to a reduced voltage; a second transformer having a secondary winding connected in series between the first transformer and the output and having a primary winding connected to the controller, the secondary and primary windings being arranged so as to induce a supplementary voltage in the secondary winding when said primary winding is energised. The controller is configured in a first phase to provide a first energising signal to the primary winding of the second transformer such as to supplement the reduced voltage provided by the first transformer, thereby to provide an output voltage signal that is greater than the reduced voltage signal; and in a second phase to short-circuit the primary winding of the second transformer, thereby to provide an output voltage signal substantially at the reduced voltage. The controller is configured in a third phase to provide a second energising signal to the primary winding of the second transformer such as to alter the reduced voltage provided by the first transformer, the second energising signal having a different voltage to the first energising signal, thereby to provide an output voltage signal in the third phase that is different to the output voltage signals provided in the first and second phases.

### CLAIM OF PRIORITY

The present application claims priority from United Kingdom Patent Application No. GB1001996.6, filed on Feb. 8, 2010, the content of which is incorporated herein by reference.

### CROSS REFERENCE TO RELATED APPLICATIONS

The present application is related to U.S. application Ser. No. ______ (Docket: VSHIP002), filed on the same date as the present application, entitled “Control Systems,” and is herein incorporated by reference.

### FIELD OF THE INVENTION

This invention relates to a control system for electrical equipment such as lighting, having particular but not exclusive application to fluorescent lighting configurations in large office blocks and industrial and retail premises.

### BACKGROUND OF THE INVENTION

With the cost of electricity being an important factor in operating lighting systems, especially on a large scale, there is a need to seek ways of reducing power consumption, to provide improved economy. This is especially true of the fluorescent lighting configurations found in large office blocks and other industrial premises.

It is known, e.g. from U.S. Pat. No. 4,956,583 to reduce the voltage supply to lights without producing a noticeable drop in light output using a transformer. This allows full rated mains voltage to be supplied at the time of switch on, with the voltage provided to the lamps being reduced after a fixed period. This also discloses reverting to mains voltage when a drop in mains voltage below a predetermined level is detected.

Also disclosed is reverting to mains voltage when it is detected that supplied current rises by more than a predetermined amount

The present invention was made in this context.

### SUMMARY OF THE INVENTION

According to a first aspect of the invention there is provided a control system, for instance for controlling lighting, computers or machinery, the control system comprising:
an input for receiving a mains supply voltage;
an output for providing an output voltage signal for powering electrical equipment;
a controller;
a first transformer connected to the input and being for reducing the mains supply voltage to a reduced voltage;
a second transformer having a secondary winding connected in series between the first transformer and the output and having a primary winding connected to the controller, the secondary and primary windings being arranged so as to induce a supplementary voltage in the secondary winding when said primary winding is energised;
the controller being configured in sequence:
   in a first phase to provide a first energising signal to the primary winding of the second transformer such as to supplement the reduced voltage provided by the first transformer, thereby to provide an output voltage signal that is greater than the reduced voltage signal;
   in a second phase to short-circuit the primary winding of the second transformer, thereby to provide an output voltage signal substantially at the reduced voltage; and
   in a third phase to provide a second energising signal to the primary winding of the second transformer such as to alter the reduced voltage provided by the first transformer, the second energising signal having a different voltage to the first energising signal, thereby to provide an output voltage signal in the third phase that is different to the output voltage signals provided in the first and second phases.

The second energising signal may be of an opposite polarity to the first energising signal, such that the output voltage signal in the third phase is lower than the output voltage signal in the second phase.

The controller may be configured to control first to third switches, for instance circuit breakers, to provide the first and second energising signals and to short-circuit the primary winding respectively.

The controller may be configured to provide the second energising signal to the primary winding of the second transformer for a predetermined time and thereafter to short-circuit the primary winding of the second transformer. Here, the controller may be configured to select the predetermined time for which the second energising signal is provided to the primary winding based in dependence on an input signal.

A second aspect of the invention comprises a lighting control system comprising:

a control system comprising:
an input for receiving a mains supply voltage;
an output for providing an output voltage signal for powering electrical equipment;
a controller;
a first transformer connected to the input and being for reducing the mains supply voltage to a reduced voltage;
a second transformer having a secondary winding connected in series between the first transformer and the output and having a primary winding connected to the controller, the secondary and primary windings being arranged so as to induce a supplementary voltage in the secondary winding when said primary winding is energised;
   the controller being configured in sequence:
      in a first phase to provide a first energising signal to the primary winding of the second transformer such as to supplement the reduced voltage provided by the first transformer, thereby to provide an output voltage signal that is greater than the reduced voltage signal;
      in a second phase to short-circuit the primary winding of the second transformer, thereby to provide an output voltage signal substantially at the reduced voltage; and
      in a third phase to provide a second energising signal to the primary winding of the second transformer such as to alter the reduced voltage provided by the first transformer, the second energising signal having a different voltage to the first energising signal, thereby to provide an output voltage signal in the third phase that is different to the output voltage signals provided in the first and second phases, and
a lamp arrangement coupled to the output of the lighting control system, the lamp arrangement comprising a lamp controller configured to decode a control signal modulated onto the output and to control the provision of power from the output to a lamp in dependence on the decoded control signal.

### BRIEF DESCRIPTION OF THE DRAWINGS

In order that the invention may be more fully understood, embodiments thereof will now be described by way of example with reference to the accompanying drawings wherein:

FIG. 1 is a block diagram of an embodiment of the invention;

FIG. 2 is a circuit diagram of a control system useable in the system of FIG. 1 but outside the scope of the invention;

FIG. 3 is a circuit diagram of a second control system of the useable in the system of FIG. 1 but outside the scope of the invention;

FIG. 4 is a block diagram of a control circuit CC shown in FIG. 3;

FIGS. 5a, b, c and d illustrates waveforms developed in the detector circuit of FIG. 4;

FIG. 6 is a circuit diagram of a third example of a control system of the invention according to the embodiment of FIG. 1;

FIG. 7 is a circuit diagram of a fourth example of a control system of the invention according to the embodiment of FIG. 1;

FIG. 8 is a block diagram of a lamp arrangement controllable by the control system of FIG. 7; and

FIG. 9 shows a transformer arrangement, in accordance with one embodiment.

### DETAILED DESCRIPTION OF PREFERRED EMBODIMENTS

Throughout the Figures, like reference numerals denote like elements.

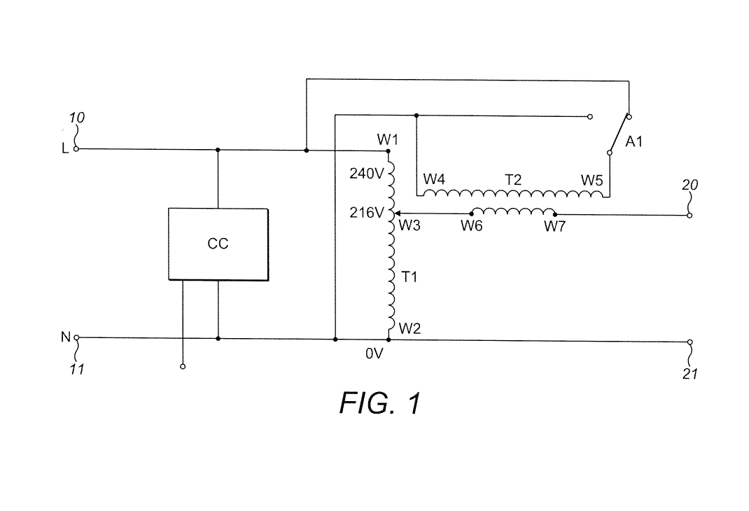

The first embodiment of the invention described with reference to FIG. 1, comprises a control system for supplying electrical power to fluorescent lamps, the supply being switched between a level approximating the mains voltage at turn on of the lamps, to a reduced voltage level which does not produce a noticeable drop in illumination but which provides a substantial improvement in economy. The system is described for use with a UK mains supply at 240 volts but it will be readily appreciated that the system can be adapted for use with other mains voltage supplies e.g. 110 volts. Mains voltage at full rating, i.e. 240 volts is provided at terminals 10, 11 and an output for supply to a bank of fluorescent lamps (not shown) is provided at terminals 20, 21. These lamps (not shown) may be connected to the terminals 20, 21 via a distribution board (not shown). A first transformer T1 in the form of an auto-transformer has winding tappings W1, W2 connected across the mains voltage supply terminals 10, 11. The transformer T1 also has an output tapping W3 which provides a voltage less than mains voltage (e.g. 216 volts) which is supplied to the output terminals 20, 21.

A second, step-down transformer T2 has its secondary winding tappings W4, W5 connectible to the mains supply terminals 10, 11 through a changeover switch contact A1. The primary winding tappings W6, W7 are connected in series with output terminals 20 and the tapping W3. A control circuit CC, shown schematically in FIG. 1, controls operation of changeover contact A1. In a first position of A1 the transformer T2 is connected to provide a voltage in its primary which increments the reduced voltage produced by transformer T1, so as to provide an output voltage at terminals 20, 21 which closely approximates full mains voltage. When the control circuit CC operates changeover switch A1 away from the position shown in FIG. 1, the terminals W4, W5 of the secondary of T2 are effectively short circuited such that T2 no longer produces the supplementary voltage and also does not impede current flow from T1 to the output terminals 20, 21.

As will be described in more detail hereinafter, the control circuit CC is so configured that upon start-up of the lamps, switch A1 is in the position shown in FIG. 1 so that a voltage approximating mains voltage is produced at terminals 20, 21, to enable switch on of the lamps. A short period thereafter, the control circuit CC switches A1 to the other position so as to disable operation of transformer T2 and thereby reduce the voltage supplied to the lamps by approximately 10% of normal mains voltage (in the case of a 240V supply, the reduced voltage is approximately 216V). The period after which the control circuit CC switches A1 to the other position so as to disable operation of transformer T2 and thereby reduce the voltage supplied to the lamps is user-configurable. The control circuit CC is controlled to vary the period from an initial value, e.g. fifteen seconds, to a user-selected value by way of a signal received via a control input 26. The control input 26 is connected to receive control signals from an input device, e.g. switch or keypad, collocated with the control system, or alternatively from a remotely located computer control system, for instance a building control system.

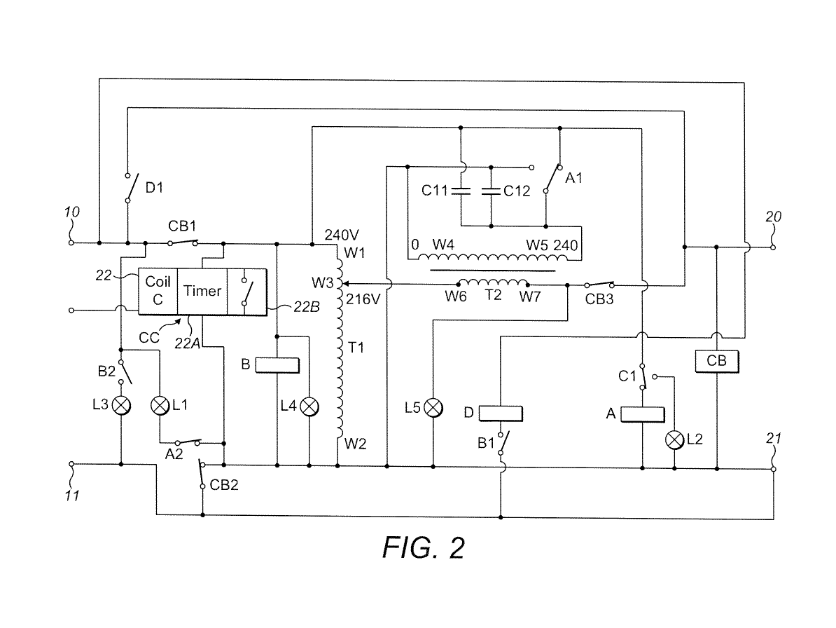

One example of the arrangement of FIG. 1 will now be described with reference to FIG. 2 in which the function of the control circuit CC is performed by a timer. This example is outside the scope of the invention.

Mains supply voltage is supplied through terminals 10, 11 to the transformer T1 via normally closed contacts CB1 and CB2 of a circuit breaker CB. The tapped output W3 of T1 is fed through the primary winding of T2 and thence through normally closed contact CB3 of circuit breaker CB. The contact A1 which controls operation of transformer T2, is operated, by contactor coil A, which has a further contact A2 that switches power to a neon lamp L1 to signify when “mains-boost” is being provided by transformer T2.

The secondary winding of transformer T2 has capacitors C11 and C12 connected to the live and neutral rails respectively to suppress switching transients produced by operation of contact A1 Operation of the contactor A is controlled by a relay 22 having a control coil C, a timer module 22a and an actuator switch 22b of known configuration The coil C controls operation of changeover contact C1, which in the position shown in FIG. 2 supplies current to the contactor A and in its other position energizes neon lamp L2 that indicates that the system is running in “economy mode.”

A further relay B is provided which operates contact B1 that switches power to a contactor having a coil D which operates contact D1. Also, the relay B operates contact B2 in order to switch voltage to neon lamp L3.

The control system shown operates as follows. When it is desired to operate the lamps, power is initially connected to the terminals 10, 11 by switching circuits (not shown).

The user then actuates switch 22b which causes the relay to be released for a period determined by the timer module 22b so that contact C1 moves into the position shown in FIG. 2. The period determined by the timer module 22b is user-configurable, and is adjusted by way of the control input 26. Consequently, the “economy mode” neon lamp L2 is switched off Contactor coil A is energized and its contacts A1 and A2 are moved into the positions shown in the Figure. The closure of A2 causes “mains boost” neon lamp L1 to be illuminated. The switching of A1 causes the secondary of transformer T2 to be connected across the mains rails. This allows the supplementary voltage from transformer T2 together with the output from transformer T1 to be applied to the fluorescent lamps connected to terminals 20, 21. The output from transformer T1 is typically 216 volts and transformer T2 provides a supplementary voltage of approximately 24 volts to give a full 240 volts mains requirement. The timer module 22a is set to give sufficient time for the lamps to ignite using their associated starters, before timing out (e.g. 15 seconds).

Thereafter, the, relay 22 is actuated to cause contact C1 to move to the alternative position to that shown in FIG. 2, so that contactor coil A is de-energized, causing contact A1 to move to the alternative position so that the secondary winding of T2 is disconnected from terminal 10 and effectively short circuited to prevent any unwanted power losses. Contact A2 switches off neon lamp L1. Capacitors C11, C12 suppress any unwanted spikes resulting from switching of A1. With contact A1 in this position, no supplementary voltage is produced by the primary of T2 and the output at terminals 20 and 21 is provided solely by the transformer T1 i.e. 216 volts.

As the output is taken through the primary of transformer T2, the transformer is wound so as to provide a low impedance path to minimize losses. The system provides power at this reduced voltage continuously thereafter to give the desired saving in power consumption.

Should the system become overloaded, the circuit breaker CB having a rating of, say, 50 amps actuates causing contacts CB1-CB3 to open. This isolates transformer T1 from the input and output terminals 10, 11 and 20, 21 and in effect isolates transformer T2. Opening of CB1 and CB2 also de-energizes relay B so that contacts B1 and B2 close. Neon lamp L3 lights due to the closure of B2 so as to signify the overload condition. The closure of contact B1 causes contactor D to energize which closes contact D1 thereby providing a direct connection between terminals 10 and 20, bypassing the control system to prevent damage thereto and to permit the system to continue to operate. Should the overload be due to a fault condition, fuses (not shown) associated with the lamps would blow in the normal way.

Neon lamps L4, L5 indicate when the secondary and primary sides of the transformer T1 are energized; both neon lamps are actuated in normal operation of the circuit.

It will appreciated that other values for the reduced and supplementary voltages could be selected. However with the values used in the example described with reference to FIG. 2, it has been found that with a wattmeter fitted, tests have indicated a saving in the region of 20% of the power consumed for a negligible loss in light output.

By switching only the supplementary power in the manner described, it has been possible to reduce dramatically the power rating of the contact (A1) needed. For example a 20 kW system can be handled with a contact rating of only 10 amps without the deterioration associated with switching large loads.

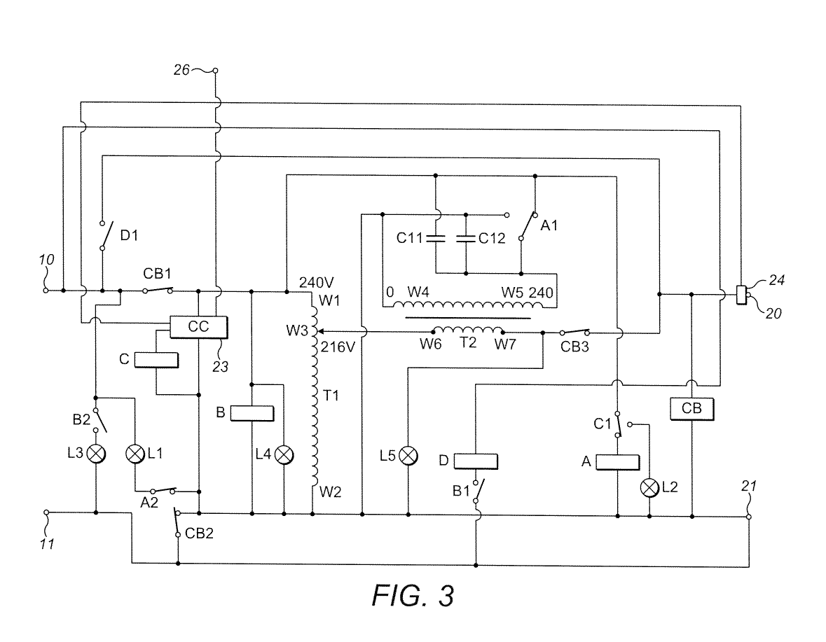

Referring now to FIG. 3, another example of the arrangement of FIG. 1 is described in more detail. This example is outside the scope of the invention. In the circuit of FIG. 3, the control circuit CC comprises a circuit arrangement 23 which utilizes a current sensor 24 that senses pulses in current supplied through the output terminal 20.

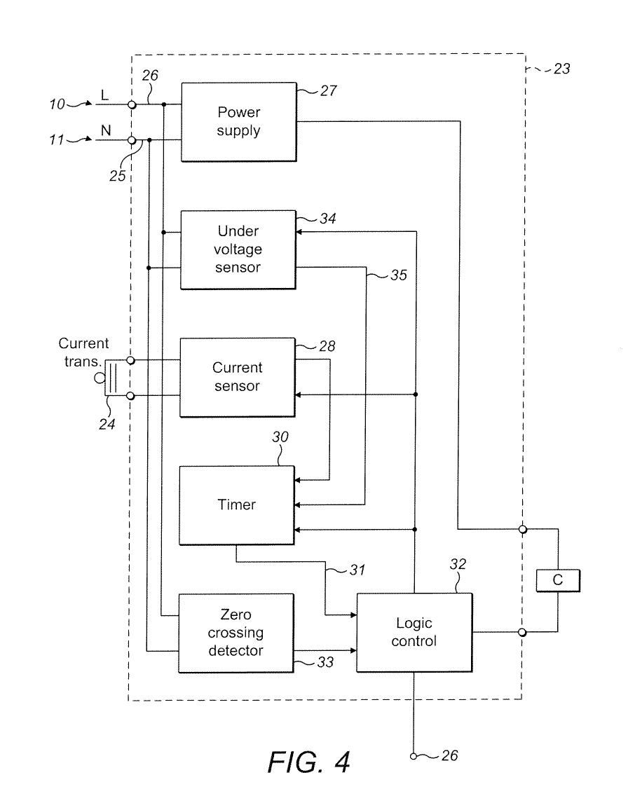

It has been appreciated that when the lamps are switched on, there is an initial current surge. The detector 24 comprises a transformer coil formed around the lead to terminal 20, which has induced therein a current pulse in response to the current surge produced by switch-on of the lamps. The induced current pulse is used to trigger circuit 23 so as to cause operation of a low voltage relay C, which actuates C1 and hence A1 in the manner previously described, in order to provide to output terminal 20 a voltage approximating the mains voltage, which comprises the reduced voltage from transformer T1 together with the supplemental voltage from transformer T2. After a predetermined period defined by a timer in circuit 23, the supplementary voltage from transformer T2 is switched off. The details of the control circuit 23 will now be described in more detail with reference to FIG. 4.

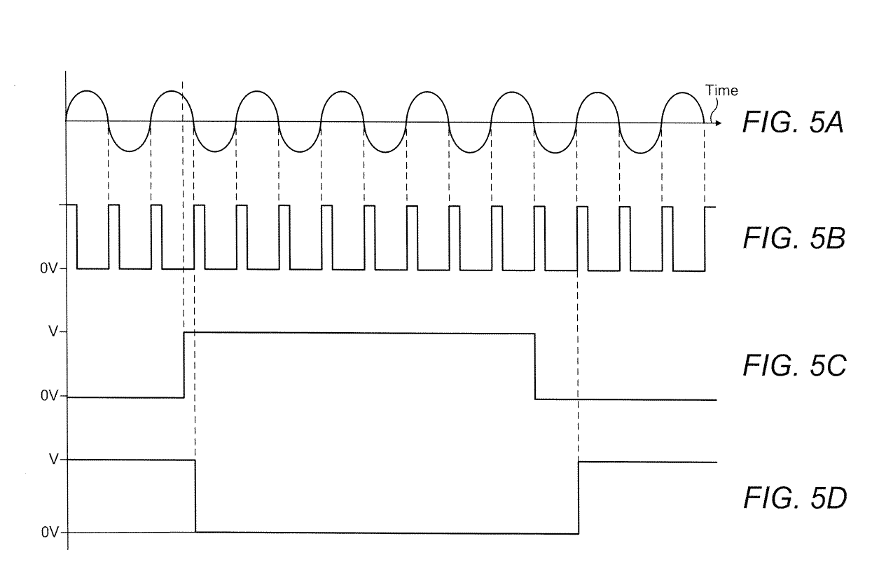

Referring to FIG. 4, mains input from terminals 10, 11 is applied to lines 25, 26, the waveform being shown in FIG. 5A, and hence to an integrated power supply circuit 27 which produces a 24 volts supply for the coil of relay C. The current sensing transformer 24 is connected to an integrated current sensing circuit 28 which is adapted to produce an output pulse on line 29 when the current transformer 24 detects that the current supplied through output terminal 20 (FIG. 3) rises by more than a predetermined amount, over a predetermined current range.

The predetermined amount of current increase is configurable by a user. A value for the predetermined amount of current increase is provided by way of the input 26, from an input device co-located with the control system or from a remotely located terminal. As an initial value, the circuit 28 may be configured to detect rapid current rises in excess of 2.5 amps over a range of 0 to 80 amps.

The circuit does not respond to a fall in current so as to avoid spurious triggering. An output pulse on line 29 triggers an integrated circuit programmable timer 30 which produces on line 31 a logical “1” output for the duration of its timing period, shown in FIG. 5C. This period controls the duration for which the supplementary voltage from transformer T2 is supplied. The period is configurable by a user by way of the input 26, from an input device co-located with the control system or from a remotely located terminal.

A control logic circuit 32 is provided with a time base signal derived by a zero crossing detector circuit 33 which produces a pulse for each zero crossing of the ac mains supply, as shown in FIG. 5B. The logic circuit 32 thus switches current through the coil of relay C for a period shown in FIG. 5D and defined by a predetermined number of half cycles of the ac wave form (as detected by detector 33) during which the timer 30 provides its logical “1” output.

Referring again to FIG. 3, when coil C is energized, contact C1 causes contactor A to be energized so that contact A1 assumes the position shown in FIG. 3 thereby producing an output voltage at terminals 20, 21 comprising both the reduced voltage from T1 and the supplementary voltage from T2. At the end of the time period, coil C is de-energized and the supplementary voltage from transformer T2 is disconnected. In practice, the, mains supply voltage may vary substantially and reductions of 10% or more may occur during periods of peak demand. This reduction may itself reduce the value of the voltage produced by transformer T1 to a level at which a noticeable reduction in light emission from the lamps may occur or, in the case of fluorescent lamps, may result in them becoming extinguished. This problem is overcome by the arrangement shown in FIG. 4. An under-voltage sensing circuit 34 is connected to the supply rails 25, 26 to detect when the mains supply voltage falls below a predetermined level. The predetermined voltage level is user-configurable. The voltage level is provided to the controller 23 by way of the input 26, from an input device co-located with the control system or from a remotely located terminal. When such a fall is detected, an output is provided on line 35 to the timer circuit 30 so as to cause it to produce a logical “1” output on line 31. The timer 30 continues to produce this output until the input on line 35 is removed As a result, the relay C is operated in response to the fall in voltage and consequently when such a low voltage condition occurs, the output at terminal 20 (FIG. 3) is boosted with the supplementary voltage from transformer T2 for a period equal to the duration of the abnormally low supply voltage condition plus the timer period.

It will be appreciated that the arrangement described with reference to FIGS. 3 to 4 has the advantage that the supplementary voltage from transformer T2 is supplied automatically according to demand upon switch on of the lamps, with the advantage that it is not necessary to switch the lamps at the control circuit itself, as in the arrangement of FIG. 2. Thus, the circuit of FIG. 3 can be used with advantage for large banks of lamps as utilized in offices, shops and other industrial situations.

While in the circuit of FIG. 3 a single current sensor 24 is provided, where the environment is noisy, for example, it may be of benefit to have more than one such current transformer (e.g. one at the input and one at the output of the system) and to include an arrangement to determine whether the surge is coming from up stream or downstream. If upstream this can be taken as coming from the lights. If downstream it can be taken as spurious and ignored to avoid unwanted switching into the full voltage load.

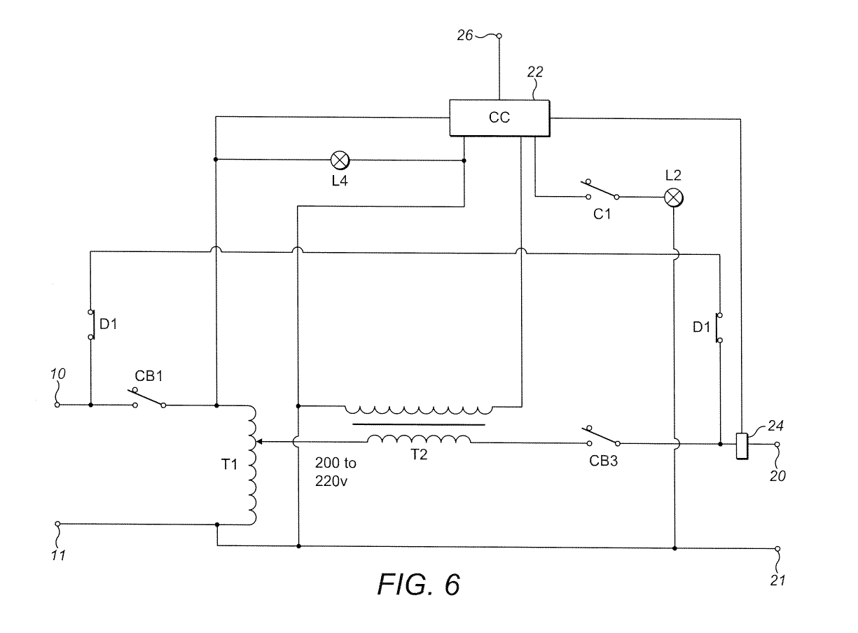

FIG. 6 is a schematic diagram of an example of the invention according to the embodiment of FIG. 1. Some of the elements of FIGS. 2 and 3 are included in the control system but are omitted from the Figure for ease of understanding.

The control circuit 22 of FIG. 6 differs from the control circuit of previous figures at least in that it is configured to be able to provide a voltage across the primary winding of the transformer T2 that is controllable to have a value between maximum and minimum voltages. The maximum and minimum voltages and the winding ratio of the transformer T2 are such that the voltage on the secondary winding can have a value between different maximum and minimum values. In this example, winding ratio is 10:1 and the input voltage can be between mains voltage and reverse polarity mains voltage (i.e. negative mains). As such, the maximum alteration of the output voltage is +24V (which is equal to 10% of the mains supply voltage) and the minimum is −24V. Electric power needed to achieve this is provided by way of the connections of the control circuit 22 to the input terminals 10 and 11.

The control circuit 22 is operable upon powering up to provide a voltage of +240V to the primary winding of transfer T2. As with the above-described control systems, this results in mains voltage of 240V being provided at the output terminals 20, 21. Following expiry of a timer, the timing period of which is user configurable, the control circuit 22 provides a voltage to the primary windings of the transformer T2 such as to provide a desired voltage at the output terminals 20, 21. The output voltage is user-configurable, control signals setting the upper voltage being received by way of the control input 26. An initial value for the output voltage may be set at 216V, and a user may then change the desired output voltage to 204V. Advantageously, the voltage level is able to be set by a user to take any value within a suitable range, for instance a range of 200 to 220V.

The control circuit 22 is configured continually to detect the level of the mains voltage received at the terminals 10, 11. The control circuit 22 is configured to adjust the voltage provided to the primary coil of the transformer T2 so as to maintain the predetermined voltage level at the output terminals 20, 21. If, for instance, mains voltage received at the input terminals 10, 11 is initially at 240V, the control circuit 22 provides a short-circuit of the primary coil of the transformer T2 in order to maintain an output voltage of 216V. If, subsequently, the mains voltage falls suddenly to 232V, this is detected by the control circuit 22, which then adjusts the voltage provided to the primary coil of the transformer T2 to a value of 80V, equating to 8V at the secondary winding of the transformer T2, thereby providing the required 216V at the output terminals 20, 21.

The control circuit 22 is configured so as to be able to adjust the voltage provided to the primary coil of the transformer T2 in incremental steps, for instance separated by 10V. In this way, the control circuit 22 is able to maintain the required output voltage at the terminals 20, 21 so long as the mains voltage received at the input terminals 10, 11 remains within a suitable range. This also allows the control circuit 22 to be able to maintain the desired output voltage in situations where the input mains voltage changes gradually over time, for instance changing from 240V to 228V over a period of 8 seconds. Instead of being able to provide voltages to the primary winding of the transformer T2 in step increments, the control circuit 22 may instead be able to provide a continuously sliding output voltage. The provision of an adjustable voltage may be best achieved through the use of a variable transformer (not shown)

An advantage provided by this arrangement is the ready accommodation of different types of lamps. In particular, although some neon lamps may provide optimum efficiency when provided with a supply voltage of 216V, optimum efficiency of other types of lamps may be found at different voltage levels. By allowing the output voltage level to be user configurable, a user can exert control over the voltage, and thus the efficiency of operation of the lamps that are connected to the control system.

A display (not shown) is controlled to display information about operation of the control system including provided current, drawn power and percentage of energy saving (or, put another way, efficiency of operation). The control circuit 22 calculates these figures from the detected parameters operating within the control system and provides corresponding signals to the display (not shown).

The control circuit 22 also is configured to send control signals to lamps that are connected to the output terminals 20, 21, as is explained in more detail below.

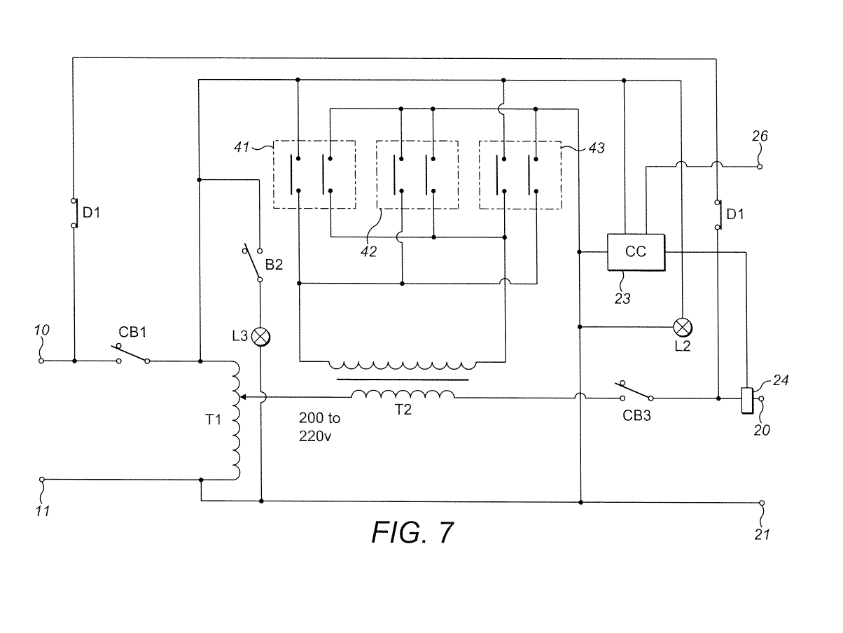

Referring now to FIG. 7, an alternative embodiment of a control system is shown. Here, some components from the FIGS. 2 and 3 systems are omitted from the figures for ease of understanding. In FIG. 7, a control circuit 23 and first to third circuit breakers 41 to 43 are used in place of the control circuit 22 of FIG. 6.

The control circuit 23 of FIG. 7 is configured to operate in a number of phases. In a first phase, the first circuit breaker 41 is controlled to be energised. In this phase, switches forming part of the first circuit breaker are closed, which results in mains voltage being provided across the primary winding of the second transformer T2. The ratios of the windings of the transformer T2 are such that this causes the voltage across the secondary winding of the second transformer T2 to be increased by 24 volts, giving rise to a mains voltage at 240 volts at the outputs 20, 21. At the end of the first phase, the control circuit 23 de-energises the first circuit breaker 41 and energises the second circuit breaker 42. In this phase, the switches of the second circuit breaker 42 are closed, which results in the primary winding of the second transformer T2 being short-circuited. Consequently, the voltage provided at the outputs 20, 21 is equal to the voltage provided at the output of the first transformer T1, which in this example is 216V. The first and second phases cooperate initially to energise the lamps connected to the outputs 20, 21 with full mains voltage and then to reduce the voltage by approximately 10%, thereby to run the lamps at increased efficiency.

In a third phase, the control circuit 23 de-energises the second circuit breaker 42 and energises the third circuit breaker 43. De-energising of the second circuit breaker 42 opens the switches of that circuit breaker, ceasing shorting of the primary winding of the second transformer T2. Energising of the third circuit breaker 43 causes the switches of that circuit breaker to be closed, thereby providing a negative voltage to the primary winding of the second transformer T2. This results in a decrease in voltage provided at the output terminals 20, 21. The amount of the decrease is equal but opposite in size to the increase that is provided to the first circuit breaker 41 in the first phase of operation. In the third phase, the output voltage provided at the terminals 20, 21 is approximately 20% lower than the input mains voltage, or approximately 192V.

In a fourth phase, the control circuit 23 is operable to de-energise the third circuit breaker 43 and to reenergise the second circuit breaker 42. In the fourth phase, the negative voltage is ceased and instead the primary winding of the second transformer T2 is again short-circuited. In the fourth phase, the output voltage at the terminals 20, 21 is approximately 10% lower than the input mains voltage, in this case approximately 216V.

As such, the control circuit 23 is operable to adjust the voltage provided at the output terminals 20, 21 to adopt any of three values, in this case 240V, 216V and 192V. The control circuit 23 uses this functionality to signal information to lamps that are connected to the outputs 20, 21.

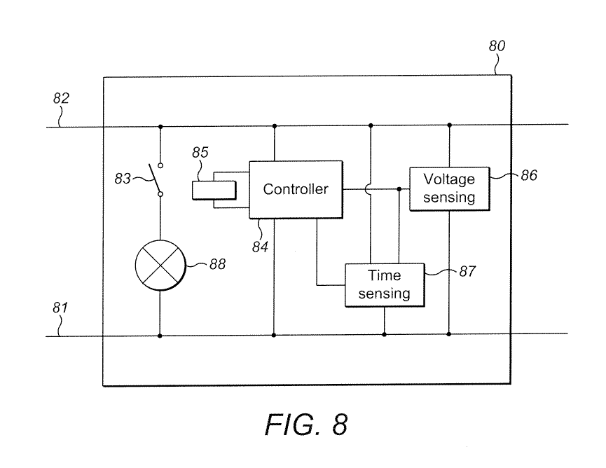

In this embodiment, the duration of the third phase is controlled by the control circuit 23 to have a value that will be understood by a lamp (shown in FIG. 8) that it is the intended recipient of a control input. Put another way, the control circuit 23 addresses a lamp connected to the output terminals 20, 21 by selecting a suitable duration of the third period. In this example, the third period is the period in which the lowest of the three available voltages is provided. The control circuit 23 is configured to measure the duration of the third phase relative to the number of phases of the AC voltage signal received at the input terminals 10, 11.

Referring to FIG. 8, a lamp station 80 is shown in schematic form. First and second lines 81, 82 are pass-through lines, extending to other lamp stations (not shown) elsewhere in the system. The lines 81, 82 are connected to the output terminals 21, 20 of FIG. 7 respectively, optionally via a distribution board (not shown).

Connected between the signal lines 81, 82 are a controller 84, a voltage sensing component 86 and a time sensing component 87. A circuit breaker 83 is connected in series with a lamp 88 between the lines 81, 82. The circuit breaker 83 is controlled by a relay 85, which is connected directly to the controller 84. The controller 84 thus is configured selectively to close the circuit provided by the circuit breaker 83 and thereby energise the lamp 88.

The voltage sensing component 86 is operable to detect the voltage present across the input lines 81, 82. The voltage sensor means thus is operable to detect whether the voltage provided is approximately equal to mains voltage, approximately equal to a first reduced voltage, for instance 216V, or as approximately equal to a second reduced voltage, for instance 196V. The voltage sensing component 86 is operable to provide an output signal to the controller 84 and the time sensing component 87 when the voltage falls from the first reduced voltage to the second reduced voltage, i.e. at the beginning of the third phase. This causes a timer in the time sensing component 87 to be started. The voltage sensing component 86 is operable to provide a second control signal when the voltage at the lines 81, 82 reverts to the first reduced voltage, i.e. at the end of the third phase. This control signal causes the time sensing component 87 to halt the timer. The time elapsed between the time sensing component 87 receiving the first and second control signals from the voltage sensing component 86 is passed to the controller 84 by way of an output of the time sensing component 87. The elapsed time may be calculated by the time sensing component 87 by counting the number of cycles of the AC waveform that have passed between receiving the two control signals. To achieve this, the time sensing component 87 may include a zero-crossing detector like the detector 33 of FIG. 4.

The controller 84 is configured to compare the duration of the third phase, as measured by the time sensing component 87, with a preset value stored internally within the controller 84. If there is a match, the controller 84 determines that the control circuit 23 of the control system of FIG. 7 has addressed a control signal to the lamp station 80. In response, the controller 84 controls the relay 85 to open the switch of the circuit breaker 83, thereby turning off the lamp 88.

On subsequently detecting that the control circuit 23 has again addressed a control signal to the lamp station 80, the controller 84 is configured to respond by controlling the relay 85 to close the switch of the circuit breaker 83, thereby again turning on the lamp 88.

On complete deenergisation of the control circuit of FIG. 7, zero voltage is provided at the output terminals 20, 21 and zero voltage thus is received by the lamp arrangement 80. In this case, the lamp 88 is deenergised and the controller 84 is reset to its initial condition. Upon subsequent energisation, the controller 84 results in the lamp 88 being illuminated, and the lamp station 80 can be controlled again by the control circuit 23 of the control system of FIG. 7 to de-energise the lamp 88.

An advantage of this arrangement is the provision of lamp control through relatively unsophisticated circuitry in the control system. Furthermore, the additional circuitry that is needed in order to provide the lamp control, that is in addition to circuitry and components that are required to exert voltage control for the purpose of improving lamp efficiency, is relatively small.

It will be appreciated that aspects of the above-described embodiments apply to the provision of power to systems other than lighting control systems. For instance, stabilised voltages, even voltages less than nominal mains voltage, are usable to advantage in power supplies for computer equipment and electrical machinery.

While the previously described embodiments concern single phase ac supplies, it will readily be appreciated that the invention can also be applied to multiphase (e.g., three phase) supplies. A supplementary voltage may be applied through a respective transformer to each of the phases of a multiphase supply under the control of a respective circuit such as control circuit 23. Alternatively, a single control circuit may be used to control injection of the supplementary voltage into all of the phases.

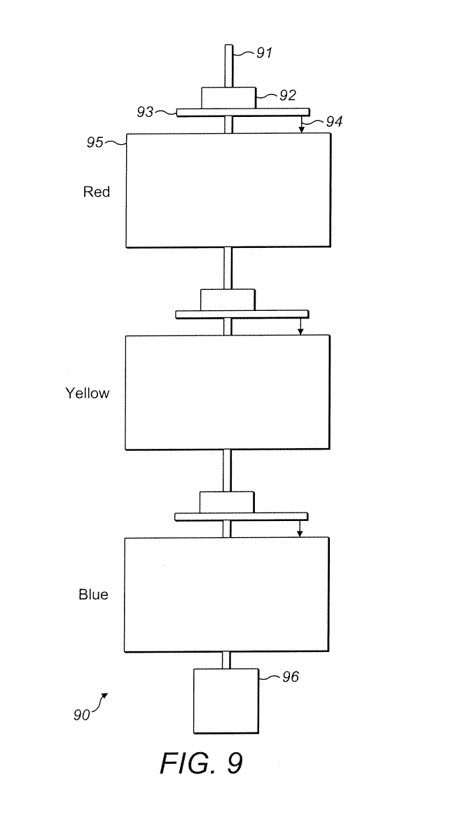

In the case of three phase voltage supplies, it is possible that mains voltage differs between different phases. In accordance with a preferred aspect of the invention, a novel transformer arrangement is used in the stabilisation of an output voltage in the presence of varying voltages in a three phase system. Reference will now be made to FIG. 9, which shows a transformer arrangement.

The transformer arrangement 90 is divided into red, yellow and blue phases. Each of the phases is substantially the same, so only the red phase will be described in detail here. A spindle 91 extends vertically through a clutch 92, a mounting plate 93 and a transformer winding 95 of the red phase. Clutches 92, mounting plates 93 and transformer windings 95 of the yellow and blue phases are also mounted on the spindle 91. A geared motor 96 is connected to the spindle at the lower-most part of the transformer arrangement 90.

A wiper 94 connects the mounting plate 93 to the transformer winding 95 in the red phase. A corresponding winder is present in the yellow and blue phases. The clutches 92 of the red, yellow and blue phases are independently controlled, so that the position of the wiper 94 on the transformer coil 95 is controllable. Furthermore, the positions of the wipers on the different ones of the red, yellow and blue phases are independently controllable. This is a result of the clutches 92 being independently controllable. It will be appreciated that in the event of all of the clutches 92 being closed, rotation of the spindle 91 by the geared motor 96 results in the positions of the wipers 94 on all of the phases varying. For each of the phases on which the clutch is open, the position of the corresponding wiper 94 does not change as the spindle rotates. Thus, selective control of the clutches 92 can allow positions of 1 or 2 or 3 of the wipers to be moved with rotation of the spindle.

By co-operating the mains transformer arrangement 90 into a control circuit, such as the control circuit 22 of FIG. 6, the output voltages of three separate phases can be controlled independently. As such, monitoring the voltages on each of the three phases and controlling an adjustment provided by the transformer arrangement 90 in each of the phases separately allows voltage stabilisation on all three of the phases.

In another embodiment, street lighting is powered by the arrangement of FIG. 6 or the arrangement of FIG. 7. In this embodiment, a light sensor is provided, and detects an ambient light level. The arrangement is able to be controlled remotely, for instance using a wireless control channel.

The arrangement is configured to vary the output voltage depending on received control signals and/or a detected ambient light level. For instance, the arrangement may provide a higher output voltage to a street lighting load, resulting in a brighter lighting output, when the ambient light detector detects a particularly low level of ambient light, consistent with a moonless or cloud-covered night sky. When the ambient light detector detects relatively high ambient light levels, for instance indicating a moonlight night sky, dawn or dusk, the arrangement may reduce the output voltage to the street lighting, reducing the brightness.

1. A control system, for instance for controlling lighting, computers or machinery, the control system comprising:
an input for receiving a mains supply voltage;
an output for providing an output voltage signal for powering electrical equipment;
a controller;
a first transformer connected to the input and being for reducing the mains supply voltage to a reduced voltage;
a second transformer having a secondary winding connected in series between the first transformer and the output and having a primary winding connected to the controller, the secondary and primary windings being arranged so as to induce a supplementary voltage in the secondary winding when said primary winding is energised;
the controller being configured in sequence:
in a first phase to provide a first energising signal to the primary winding of the second transformer such as to supplement the reduced voltage provided by the first transformer, thereby to provide an output voltage signal that is greater than the reduced voltage signal;
in a second phase to short-circuit the primary winding of the second transformer, thereby to provide an output voltage signal substantially at the reduced voltage; and
in a third phase to provide a second energising signal to the primary winding of the second transformer such as to alter the reduced voltage provided by the first transformer, the second energising signal having a different voltage to the first energising signal, thereby to provide an output voltage signal in the third phase that is different to the output voltage signals provided in the first and second phases.

2. A control system as claimed in claim 1, wherein the second energising signal is of an opposite polarity to the first energising signal, such that the output voltage signal in the third phase is lower than the output voltage signal in the second phase.

3. A control system as claimed in claim 1, wherein the controller is configured to control first to third switches, for instance circuit breakers, to provide the first and second energising signals and to short-circuit the primary winding respectively.

4. A control system as claimed in claim 1, wherein the first to third switches are circuit breakers.

5. A control system as claimed in claim 1, wherein the controller is configured to provide the second energising signal to the primary winding of the second transformer for a predetermined time and thereafter to short-circuit the primary winding of the second transformer.

6. A control system as claimed in claim 5, wherein the controller is configured to select the predetermined time for which the second energising signal is provided to the primary winding based in dependence on an input signal.

7. A lighting control system comprising:
a control system comprising:
an input for receiving a mains supply voltage;
an output for providing an output voltage signal for powering electrical equipment;
a controller;
a first transformer connected to the input and being for reducing the mains supply voltage to a reduced voltage;
a second transformer having a secondary winding connected in series between the first transformer and the output and having a primary winding connected to the controller, the secondary and primary windings being arranged so as to induce a supplementary voltage in the secondary winding when said primary winding is energised;
the controller being configured in sequence:
in a first phase to provide a first energising signal to the primary winding of the second transformer such as to supplement the reduced voltage provided by the first transformer, thereby to provide an output voltage signal that is greater than the reduced voltage signal;
in a second phase to short-circuit the primary winding of the second transformer, thereby to provide an output voltage signal substantially at the reduced voltage; and
in a third phase to provide a second energising signal to the primary winding of the second transformer such as to alter the reduced voltage provided by the first transformer, the second energising signal having a different voltage to the first energising signal, thereby to provide an output voltage signal in the third phase that is different to the output voltage signals provided in the first and second phases, and
a lamp arrangement coupled to the output of the lighting control system, the lamp arrangement comprising a lamp controller configured to decode a control signal modulated onto the output and to control the provision of power from the output to a lamp in dependence on the decoded control signal.

8. A lighting control system as claimed in claim 7, wherein the lamp arrangement comprises a timer configured to determine a time period between transitions into and out of a voltage at the output and to decode the control signal on the basis of the determined time period.
